(19) United States
(12) Patent Application Publication
(10) Pub. No.: US 2012/0151319 A1
(43) Pub. Date: Jun. 14, 2012

(54) SYSTEMS AND METHODS FOR SELF DIRECTED STRESS ASSISTANCE

(75) Inventor: Jeffery D. Eastman, St. Louis, MO (US)

(73) Assignee: CLAYTON STRESS INSTITUTE, INC., St. Louis, MO (US)

(21) Appl. No.: 12/967,264

(22) Filed: Dec. 14, 2010

(51) Int. Cl. G06F 17/20; G06F 15/16

(52) U.S. Cl. 715/221; 709/203

(57) ABSTRACT

A system and method for assisting a user cope with painful memories. The system uses a number of light sequence presentations to permit the user to self-direct a dynamically configurable Eye Movement Desensitization and Reprocessing (EMDR) session. The system dynamically configures subsequent light sequence presentations based, in part, upon feedback received from the user.

### RELATED APPLICATIONS

Not Applicable.

### FEDERALLY SPONSORED RESEARCH OR DEVELOPMENT

Not Applicable.

### COMPACT DISK APPENDIX

Not Applicable.

### BACKGROUND

Eye Movement Desensitization and Reprocessing (EMDR) is a powerful short-term psychotherapy technique which has been very successful in helping people who suffer from trauma, anxiety, panic, disturbing memories, post traumatic stress, and many other emotional problems. Often, these conditions are difficult and time-consuming to treat. EMDR is a breakthrough therapy that can bring quick and lasting relief for many types of emotional distress.

EMDR sessions are usually conducted at the office of a licensed mental health professional. These sessions are costly and limited to the availability of the licensed mental health professional. Therefore, there exists a need for an effective and affordable EMDR tool that is readily available.

### SUMMARY

According one aspect, a method is provided that allows a user to self direct a stress assistance session. The method includes receiving a stress assistance request at a server computer from a client computer. The stress assistance request includes user identification data for a particular user. An instruction form is from the server computer to the client computer for display. A survey form is transmitted from the server computer to the client computer for display. A survey storage request is then received at the server computer from the client computer. The survey storage request is generated at the client computer in response to a first survey data input into the survey form.

A first light sequence presentation is transmitted from the server computer to the client computer for display. The first light sequence presentation includes a first light sequencing pattern. The survey form is then transmitted from the server computer to the client computer for display. A second survey storage request is then received at the server computer from the client computer. The survey storage request is generated at the client computer in response to second survey data input into the survey form. A second light sequence presentation that includes a second light sequencing pattern is defined based on the first and second survey data. The second light sequence presentation is then transmitted from the server computer to the client computer for display. The second light sequence presentation also includes a second light sequencing pattern.

According to another aspect, another method for self directed stress assistance is provided that includes generating a stress assistance request. The stress assistance request includes user identification data for a particular user. An instruction form is displayed at a display of a computer. A first instance of a survey form is also displayed at the display. A survey storage request is generated at the computer in response to first survey data input into the first instance of the survey form. A first light sequence presentation is displayed at the display. The first light sequence presentation includes a first light sequencing pattern.

A second instance of the survey form is then displayed at the display. A second survey storage request at the computer device is generated in response to second survey data input into the second instance of the survey form. A second light sequence presentation is defined at the computer. The second light sequence presentation includes a second light sequencing pattern based on the first and second survey data. The second light sequence presentation is then generated to the computer for display.

According to another aspect, a system for self directed stress assistance is provided. The system includes a processor, a memory, and a user interface to display at least one light sequence presentation. The system also has a stress assistance application that includes modules executable by the processor to generate the at least one light sequence presentation. The stress assistance application includes an instruction module to transmit a login form and an instruction form for display at the user interface and to receive user identification data input into the login form. A survey module transmits a survey form for display at the user interface and receives survey data input into the survey form. A light sequencing module generates and transmits a first light sequence presentation having a first light sequencing pattern for display at the display device. A storage module stores identification data and the survey data in the memory.

In yet another aspect, a system for self directed stress assistance includes a server having a first processor, a first memory, and a stress assistance application. The stress assistance application includes modules executable by the processor to generate at least one light sequence presentation. The stress assistance application also includes an instruction module to transmit a login form and an instruction form for display at the user interface and receive user data input into the login form. A survey module transmits a survey form for display at the user interface and receives survey data input into the survey form. A light sequencing module generates and transmits a light sequence presentation that includes a light sequencing pattern for display at the display device. A storage module stores identification data and the survey data in the memory. The system also includes a remote computing device having a second processor and a second memory, a user interface to display the light sequence presentation, and an input device to input the user data and the survey data.

### BRIEF DESCRIPTION OF THE DRAWINGS

FIG. 1A is a block diagram of a computing environment for generating a light sequence presentation according to an aspect of a stress assistance system.

FIG. 1B is a screen shot of an exemplary login form.

FIG. 1C is a screen shot of an exemplary instruction form.

FIG. 1D is a screen shot of an exemplary survey form.

FIG. 1E is a screen shot of an exemplary start form.

FIG. 1F is a screen shot of an exemplary light sequence presentation.

FIG. 2 is a block diagram of another computing environment for generating and displaying light sequence presentations according to an aspect of a stress assistance system.

FIG. 3 is a flowchart that illustrates a method for dynamically configuring and generating a light sequence presentation according to an aspect of the stress assistance system.

### DETAILED DESCRIPTION

The self-directed stress assistance system is a computer based system that assists users in processing and handling painful and traumatic memories. The system uses a self-directed Eye Movement Desensitization and Reprocessing (EMDR) application to assist users in dealing with such memories. In one aspect, the system includes an EMDR application stored on a server computing device that is provided over a network to users of remote computing devices, so that the users may direct their own EMDR session. In another aspect, the system is implemented in a stand-alone computing device. By way of example, and not limitation, the stand-alone computing device may be a desktop computer, an iPhone®, or an iPad®.

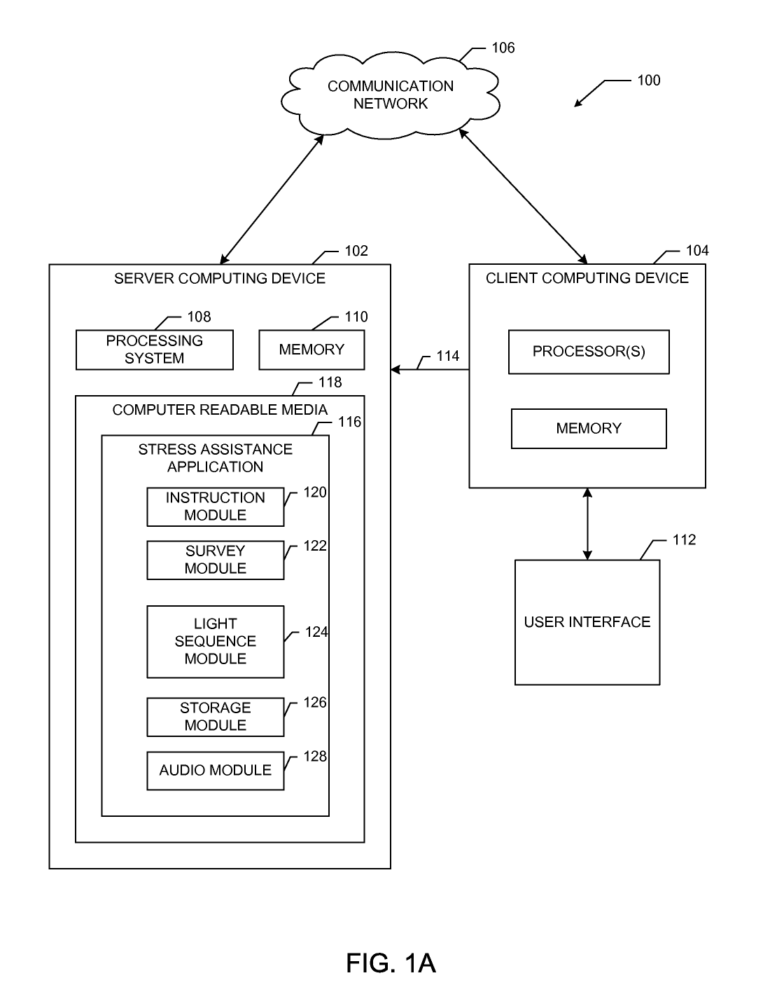

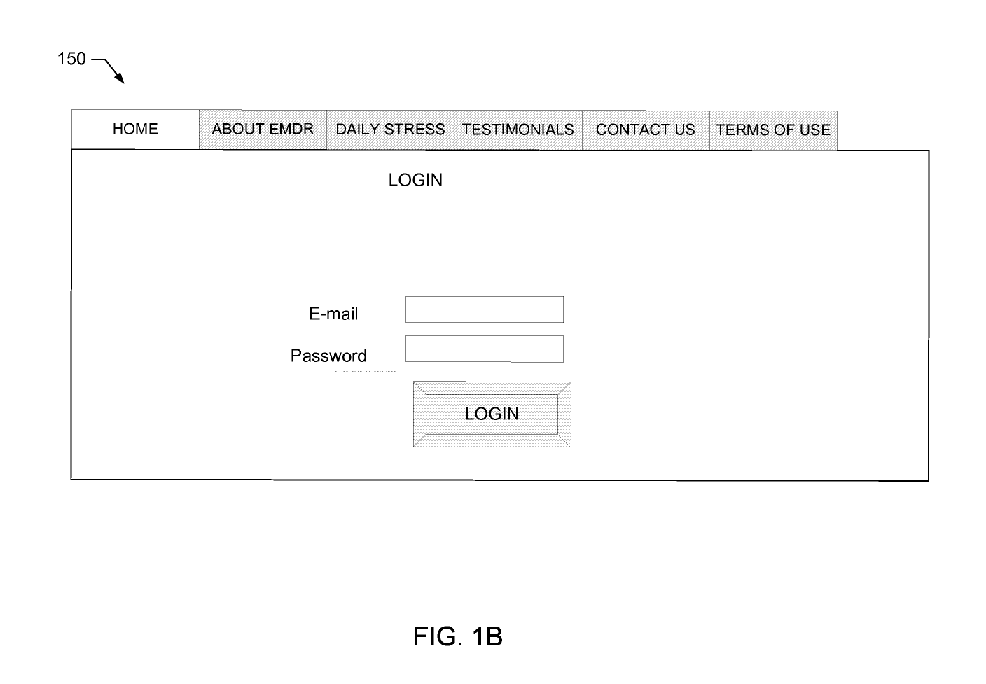

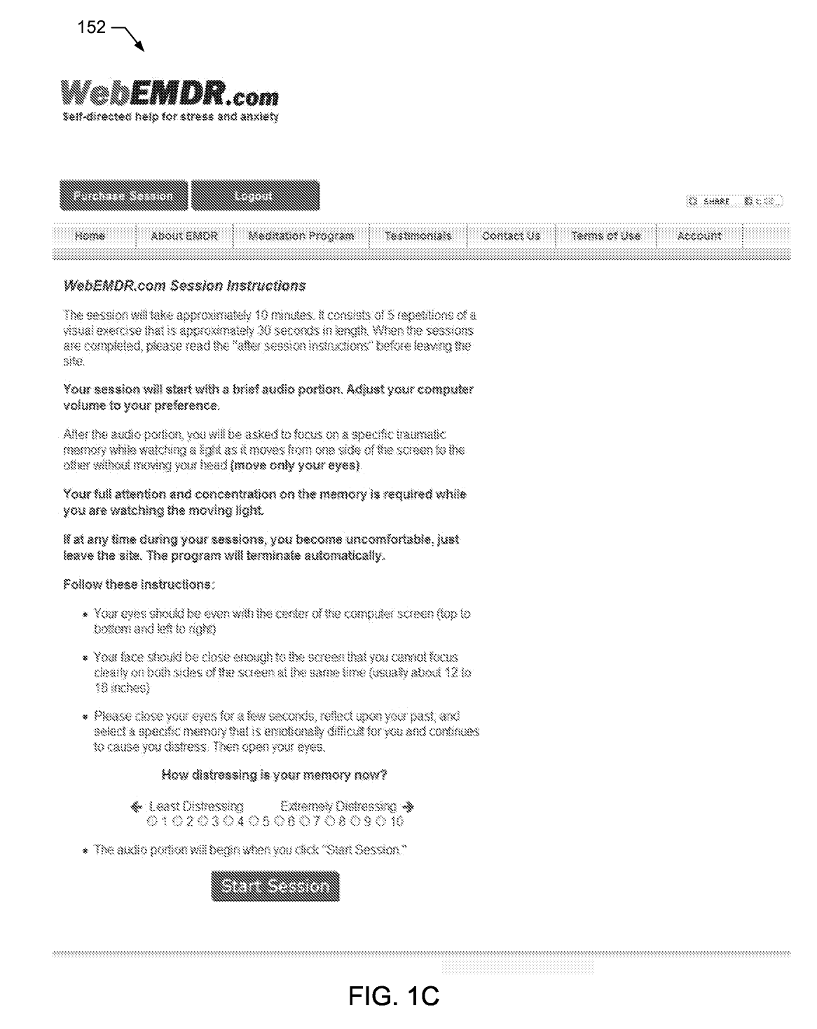

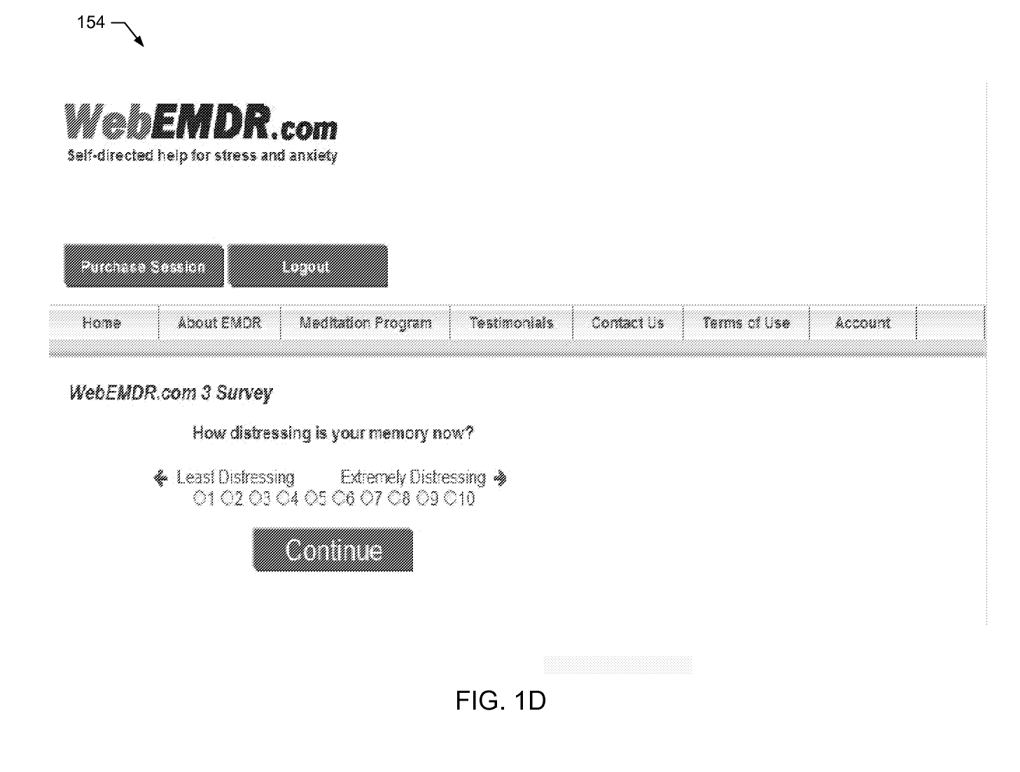

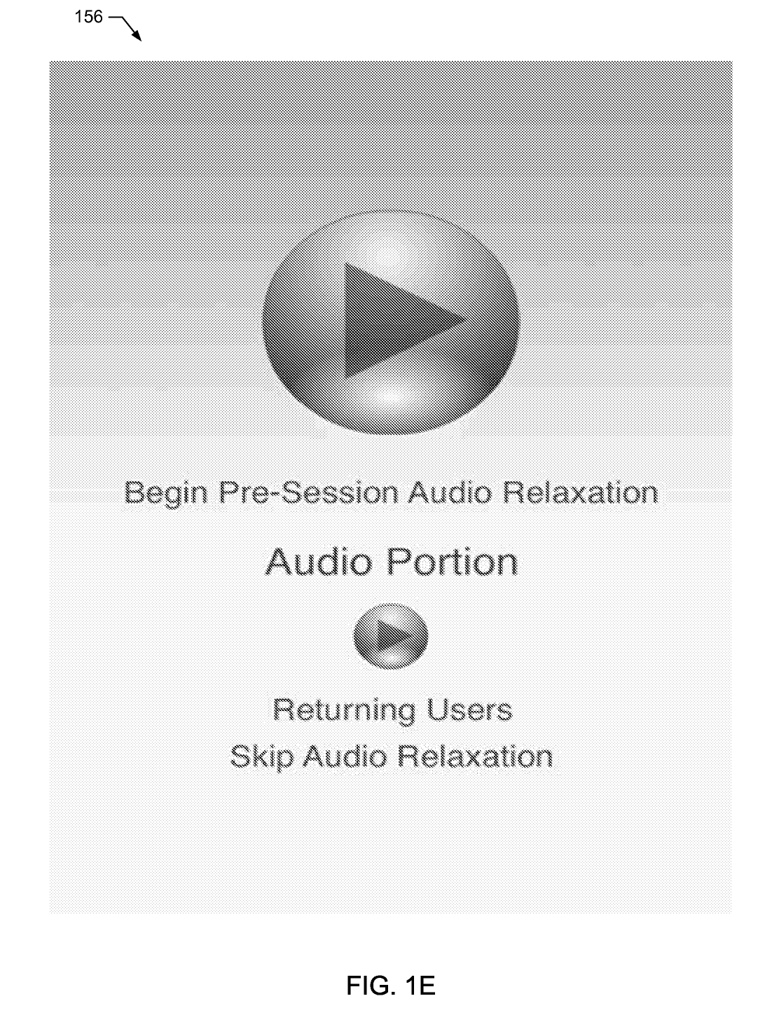

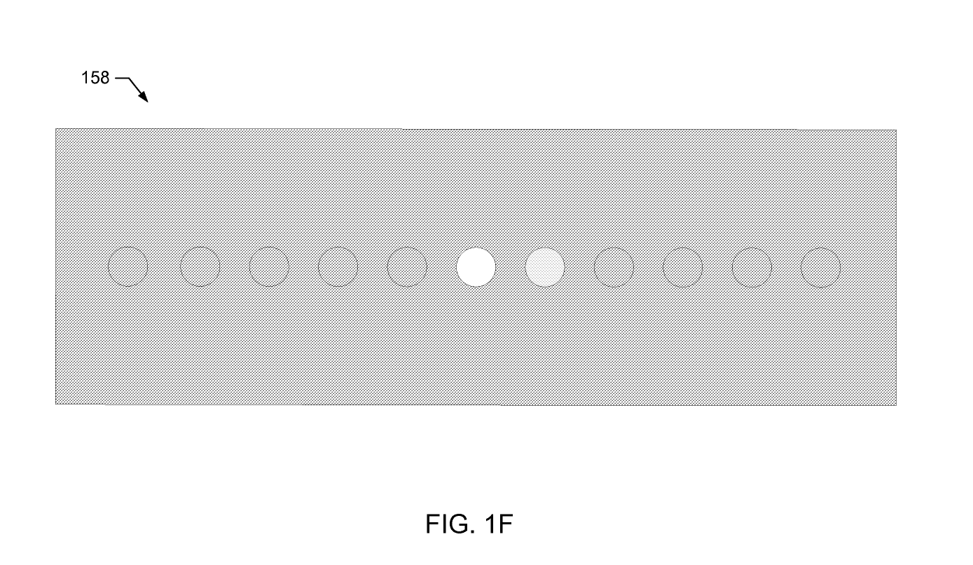

FIG. 1A is a block diagram of a computing environment for generating a light sequence presentation according to an aspect of a stress assistance system 100. The stress assistance system 100 includes a server computing device 102, a portable client computing device 104, and a communication network 106 to enable data communication between the server computing device (“server”) 102, and the portable client computing device (“client”) 104.

The server 102 includes a processing system 108 and a memory 110. In one aspect, the server 102 may also include a database (not shown) that stores stress assistance presentation data and user identification data. Stress presentation data includes, for example, one or more light sequence presentations, as explained in more detail below. The user identification data includes name data, gender data, contact data, authentication data, and other user data for registered users.

The client 104 is, for example, a computer or processing device, such as a personal computer or a lap top computer. The client includes a graphical user interface 112 that enables a user to generate a stress assistance request 114 and/or view stress presentation data. For example, the graphical user interface 112 includes a display, such as a computer monitor, specialized goggles, or eye patches for viewing stress presentation data and an input device, such as a keyboard or a pointing device (e.g., a mouse, trackball, pen, touch pad, or other device), for entering user identification data and/or generating the stress assistance request 114. The stress assistance request 114 is generated, for example, by the user interacting with the graphical user interface 112 to select a start control on an input form being displayed on the screen.

The communication network 106 can be the Internet, an intranet, or another communication network. According to one aspect, the server 102 and the client 104 may communicate data among themselves via the communication network 106 using a Hypertext Transfer Protocol (HTTP), which is a protocol commonly used on the Internet to exchange information between clients and servers. According to another aspect, the server 102 and the client 104 communicate data among themselves via the communication network 106, using a Wireless Application Protocol (WAP) which is a protocol.

The server 102 executes a stress assistance application 116 in response to the stress assistance request 114 received from the client 102 to generate and transmit a self-directed stress assistance presentation that includes a dynamically configurable light sequence presentation to the client 104. The user views the light sequence presentation at the client 104 to assist with their stress of painful memories. As another example, the stress assistance application 116 generates two or more light sequence presentations where the latter presentations(s) are dynamically configurable based, at least in part, upon the user's response to the preceding presentation as quantified by data input at the client 104.

According to one aspect, before the user can access the light sequence presentations of the stress assistance application 116, the user of the client 104 interacts with the graphical user interface 112 to generate the stress assistance request 114. The stress assistance request 114 is generated, for example, by a user interacting with the graphical user interface 112 to input user identification data and/or authentication data, such as a username and/or a password into an authentication or login form displayed on the graphical user interface 112. The stress assistance application 116 transmits the stress assistance request 114 to the server 102 for authentication and initiation of a stress assistance protocol. A stress assistance protocol includes the display of one or more light sequence presentations accompanied by the display of one or more instruction and survey forms. In one aspect, at least one instruction or survey form is displayed before and/or after each light sequence presentation.

If the stress assistance request 114 is determined to correspond to an authorized user at the stress assistance application 116, the application generates a stress assistance protocol for that user. In one aspect, the stress assistance protocol is based upon the identification and/or authentication data input by the user. In another aspect, the stress assistance protocol is also based upon past and or current survey and instruction data input by the user.

The processing system 108 includes one or more processors that execute the stress assistance application 116 to transmit and/or display the stress assistance presentation. In one aspect, a stress assistance presentation includes one or more instructions forms, one or more survey forms, and one or more light sequence presentations. In other aspects, additional forms and/or presentations may be generated and transmitted with the stress assistance presentation.

The server 102 includes a computer readable medium (“CRM”) 118 configured with the stress assistance application 116. The stress assistance application 116 includes instructions or modules 120-128 that are executable by the processing system 108 to generate and transmit the stress assistance presentation for display at the client 104.

The CRM 118 may include volatile media, nonvolatile media, removable media, non-removable media, and/or another available medium that can be accessed by the client 104. By way of example and not limitation, the CRM 118 comprises computer storage media and communication media. Computer storage media includes memory, volatile media, nonvolatile media, removable media, and/or non-removable media implemented in a method or technology for storage of information, such as computer readable instructions, data structures, program modules, or other data. Communication media may embody computer readable instructions, data structures, program modules, or other data and include an information delivery media or system.

An instruction module 120 generates an authentication or login form that is transmitted to the client 104. Once the user has input acceptable identification data into the login form, the stress assistance request 114 is generated at the client 104. The stress assistance request 114 is received at the instruction module 120 which then generates an instruction form. A screen shot of an exemplary login form 150 is depicted in FIG. 1B.

The instruction form is transmitted to the client 104. The instruction form provides the user with instructions for using the stress assistance application 116. More specifically, the instruction form instructs users on the viewing of the light sequence presentations and the completion of a survey form generated by the survey module 122. In one aspect, the instruction module 120 generates and transmits the instruction form prior to the display of a light sequence presentation only. In another aspect, the instruction module 120 generates one or more varied instruction forms that are displayed prior to or after each light sequence presentation. A screen shot of an exemplary instruction form 152 is depicted in FIG. 1C.

A survey module 122 generates a survey form that is transmitted to the client 104 to gather data from the user of the stress assistance application 116. In one aspect, the survey form receives input to determine a user's emotional discomfort prior to and/or after viewing a light sequence presentation. Once a user has input survey data into the survey form, a survey storage request is generated at the client 104 in response to the data input into the survey form. The survey storage request is used to transmit the survey data input into the survey form to the server 102. A screen shot of an exemplary survey form 154 is depicted in FIG. 1D. In this screenshot, the user rates their discomfort on a scale of 1-10. In various other aspects, the survey form may include additional survey questions and other quantifiable methods of accessing a user's discomfort.

The survey module 122 also generates a start form that is transmitted to the client 104 after the user of the client has completed the survey form. The user interacts with the start form via the graphical user interface to select a start button displayed on the screen. A screen shot of an exemplary start form 156 is depicted in FIG. 1E.

The light sequencing module 124 generates and transmits one or more light sequence presentations to the client 104 for display in response to the stress assistance request 114. The light sequence presentation includes a light sequencing pattern for display. This light sequencing pattern is viewed by the user of the client 104 in self-directed EMDR stress assistance session.

The light sequencing pattern includes two or more displayed lights that are illuminated in a pattern to elicit a specific pattern of eye movements from the user viewing the pattern. For example, the light sequence presentation may include a light sequencing pattern that uses 8-12 lights horizontally aligned on the display. Other examples exist. In one aspect, the desired pattern of eye movements is predetermined prior to display of the pattern in order to stimulate blood flow and neural activity in particular portions of the users brain. The desired brain activity is believed to assists users in coping with painful memories.

In another aspect, the light sequencing pattern is dynamically configured to alter the pattern in which the displayed lights are illuminated. As explained more fully, below, the configurable sequencing pattern is altered such that the user's neural activity occurs at different locations and/or different temporal rates. For example, the duration of the interval between illuminations of the displayed lights may be varied. In this example, the duration may be changed by as little as a millisecond or a part thereof. Other examples and durations exist.

In another aspect, the duration interval, intensity, frequency, color, pattern, and images displayed during the light sequence presentation can all be varied based on the user's response. In this aspect, the user's response may be input to the survey form using a keyboard, pointer, or measured by a device that measures galvanic skin responses, blood pressure, heart rate, respiration rate and intensity, and skin conductivity, or other physiological parameters.

A screen shot of an exemplary light sequence presentation 158 is depicted in FIG. 1F. As depicted in this example, the light sequence presentation consists of eleven displayed lights that may be illuminated in a pre-determined pattern. In one aspect, the pattern is dynamically configured based, in part, upon input received at the survey module 122. In various aspects, the order in which the lights are illuminated, the duration of illumination, the duration between illumination, and the number of lights illuminated at one time are configurable and can vary according to the defined pattern.

In one aspect, the user is instructed to focus upon the same memory during each light sequence presentation. In other aspects, the user is instructed to perform additional activities including, but not limited to refocusing upon the specific memory being addressed, performing various relaxation techniques, and/or inputting self-evaluated survey data to identify any quantifiable changes in the user's emotional response to the specific memory. In other aspects, the changes in the user's emotional response are transmitted from the client 104, received at the survey module 122, and stored by the storage module 126.

In another aspect, the light sequencing presentation includes a visual light sequence and audio sequence. In this aspect, the audio sequence includes ear pulsing or other sounds that may be in phase or out of phase with the eye movements. In other aspects, the audio sequence is presented without the inducing eye movements.

The storage module 126 stores data, such as identification data and survey data, received from the client 104 into the memory 110 or the server database (not shown). In one aspect, the storage module 126 also receives data stored at the server. The stored data is used by one or more other modules including but not limited to the instruction module 120, survey module 122, and light sequence module 124 to configure the instruction form, survey form, and light sequence presentation, respectively, for each user.

The audio module 128 generates and transmits an audio presentation to the client device. In one aspect, the audio presentation includes instructions that are to be heard by the user. In another aspect, the audio module 128 generates and transmits an audible relaxation presentation that is useful in helping the user relax before, during, and/or after each light sequence presentation. For example, the audio presentation may include music, relaxation sounds, and/or spoken words designed to relax the user. In one aspect, the audio presentation is only presented before the first light sequence presentation, while the instruction form is displayed after each of the first four light sequence presentations. Other examples exist.

Although FIG. 1A illustrates a single client 104 communicating with the server 102, it is contemplated that multiple clients 104 can communicate with the server 102. As a result, the server 102 can generate and transmit dynamically configurable stress assistance presentations to multiple clients 104.

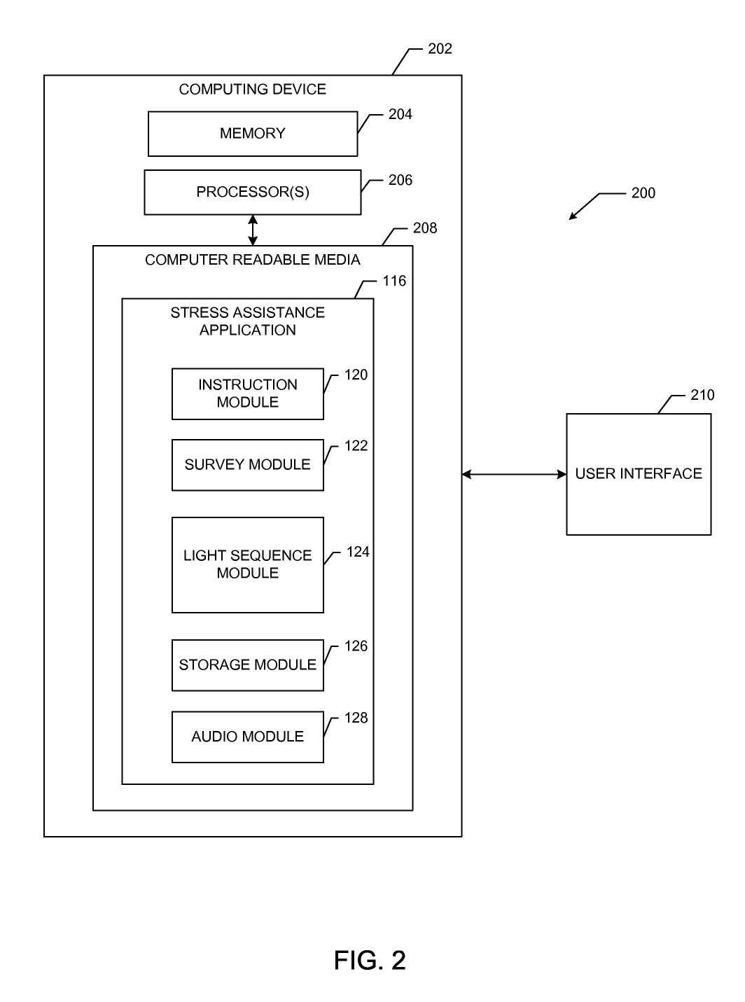

FIG. 2 is a block diagram that depicts another aspect of a stress assistance system 200. In this aspect, the stress assistance application 116 and its associated modules 120-128 are encoded on a CRM 208 that is processed by the processor(s) 206 of a stand-alone computing device 202. The computing device 202 includes a memory 204 and a graphical user interface 210. The CRM 208 and the graphical user interface 210 are identical in function to the CRM 118 and graphical user interface 112 as depicted in FIG. 1A.

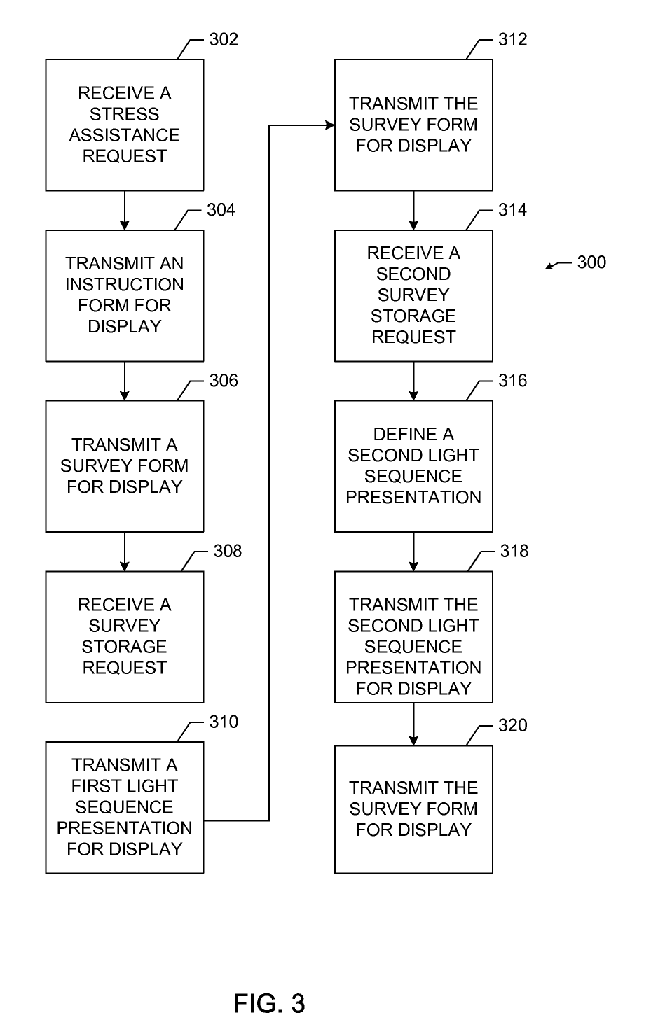

FIG. 3 is a flowchart that illustrates an exemplary method for dynamically configuring and generating a light sequence presentation according to an aspect of the stress assistance system. At 302, the stress assistance application 116 receives a stress assistance request 114. In one aspect, the stress assistance request 114 is received at the server 102 from the client 104, after a user has input user identification data in to a login form. In another aspect, the stress assistance request 114 is received at the instruction module 120 from the processor 206 of the computing device 202 (e.g., see FIG. 2).

At 304, the instruction module 120 transmits an instruction form to the graphical user interface 112 for display. The survey module 122 then transmits a survey form to the graphical user interface 112 for display at 304. In one aspect, the instruction form and the survey form may be transmitted to the graphical user interface 112, simultaneously. In another aspect, the data within the instruction form and the survey form may be incorporated into a single form that is transmitted to the graphical user interface 112 for display.

After the user inputs data into the instruction form and/or the survey form, the survey module 122 receives a survey storage request at 308. The light sequence module 124 then transmits, at 310, a first light sequence presentation to the graphical user interface 112 for display. The survey module 122 again transmits the survey form, at 312, to solicit input regarding the user's response to the first light sequence presentation. At 314, a second survey storage request is received at the stress presentation application 116. Based upon the second survey storage request, the stress presentation application 116 defines a second light sequence presentation at 316 and transmits to graphical user interface 112 for display at 318. In one aspect, the second light sequence presentation is different from the first light sequence presentation. For example, the stress presentation application 116 generates second light sequence by adjusting the timing and/or sequencing of the lights displayed in the first light sequence presentation based on the survey data received at 314.

In one aspect, the survey module 122 generates a start form for display prior to the transmission of each light sequence presentation. In this aspect, the user directs the transmission of each light sequence, so that the user can proceed at a pace with which they are comfortable.

At 320, the survey module 122 transmits the survey form to the graphical user interface 112 for display to elicit additional feedback regarding the user response to the second light sequence presentation. In one aspect, one or more additional light sequence presentations are defined and transmitted by the light sequence module 124. In this aspect, the additional presentations are defined, at least in part, by the feedback regarding one or more preceding presentations received at the survey module 122.

By way of example and not limitation, a typical light sequence presentation protocol may consist of five light sequence presentations. In this example, the display of each presentation is preceded by the display of an instruction form and/or a survey form. Similarly, the final presentation is followed by a debriefing instruction form and a final survey form.

### An Example Light Sequence Presentation Protocol

By way of example and not limitation, the stress assistance application may display a light sequencing protocol that includes three cycles of light sequence presentations. In this example, a stress assistance request 114 is received from user of a computing device who has input identification and/or authorization data at a graphical user interface. The stress assistance application then transmits an instruction form that asks the user to focus on a painful memory and a survey form that asks the user to rate their discomfort level (a scale of 1 to 10) while focused on the memory. In this example, the user indicates a discomfort level of five or greater on the ten point scale. Once the user has reviewed the forms and rated their discomfort level, the first light sequence presentation is transmitted to the graphical user interface. At the user's direction, the first light sequence presentation commences.

The light sequence presentation includes a display having 2-20 lights horizontally arranged on the graphical user interface. The precise number of lights is dependent, in part, upon the viewable area of the display device. For a first light sequence presentation having 8-12 lights, the sequence consists of a illuminating one light, then the adjacent light and so on. Only one light is illuminated at a time. The sequence will include approximately 20 rounds trips back and forth across the display and take approximately 25 seconds. The length of time between the illuminations of each light is approximately 60 milliseconds.

After the first light sequence presentation, a self-directed pause allows the user to proceed at their own pace. Once the user is ready to proceed, a second survey form is generated; the user indicates no change in their response to the memory and indicates that their discomfort level is still a five or greater. In response to this second survey data, the stress assistance application determines that no change in the discomfort level as been indicated and therefore defines a second light sequence presentation where the length of time between the illumination of each light is approximately 40 milliseconds.

At the user's direction, the second light sequence presentation commences, after which the user again indicates their discomfort level. If after the light sequence presentation, the user again indicates that there is no change in the response to the memory and the discomfort level remains at five or greater, the third light sequence presentation has a duration of 34.8 milliseconds between illumination.

Those skilled in the art will appreciate that variations from the specific aspects disclosed above are contemplated by the invention. The invention should not be restricted to the above aspects, but should be measured by the following claims.

What is claimed is:

1. A method for self directed stress assistance:
receiving a stress assistance request at a server computer from a client computer, the stress assistance request comprising user identification data for a particular user;
transmitting an instruction form from the server computer to the client computer for display;
transmitting a survey form from the server computer to the client computer for display;
receiving a survey storage request at the server computer from the client computer, the survey storage request being generated at the client computer in response to first survey data input into the survey form;
transmitting a first light sequence presentation from the server computer to the client computer for display, the first light sequence presentation comprising a first light sequencing pattern;
transmitting the survey form from the server computer to the client computer for display
receiving a second survey storage request at the server computer from the client computer, the survey storage request being generated at the client computer in response to second survey data input into the survey form;
defining a second light sequence presentation comprising a second light sequencing pattern based on the first and second survey data; and
transmitting the second light sequence presentation from the server computer to the client computer for display, the second light sequence presentation comprising a second light sequencing pattern.

2. The method of claim 1 further comprising transmitting an audio relaxation presentation from the server to the client computer.

3. The method of claim 1 further comprising:
transmitting another instruction form from the server to the client computer prior to transmitting the second light sequence presentation to the client computer for display.

4. The method of claim 1 wherein the first light sequencing pattern is predetermined.

5. The method of claim 1 wherein the first light sequencing pattern is determined based upon the user identification data for the particular user.

6. The method of claim 1 wherein the first light s sequencing pattern is determined based upon the first survey data input.

7. The method of claim 1 wherein the second light sequencing pattern is predetermined.

8. The method of claim 1 wherein the second light sequencing pattern is determined based upon the user identification data for the particular user.

9. The method of claim 1 wherein the second light sequencing pattern is determined based upon the user identification data for the particular user, the first survey data input, and the second survey data input.

10. The method of claim 1 wherein a duration between two or more light patterns of the second light sequencing pattern is increased when the second survey data input equals the first survey data input.

11. The method of claim 1 wherein a duration between two or more light patterns of the second light sequencing pattern is decreased when the second survey data input equals the first survey data input.

12. The method of claim 1 wherein an order of two or more light patterns of the second light sequencing pattern is altered when the second survey data input equals the first survey data input.

13. A method for self directed stress assistance:
generating a stress assistance request, the stress assistance request comprising user identification data for a particular user;
displaying an instruction form at a display of a computer;
displaying a first instance of a survey form at the display;
generating a survey storage request at the computer in response to first survey data input into the first instance of the survey form;
displaying a first light sequence presentation at the display, the first light sequence presentation comprising a first light sequencing pattern;
displaying a second instance of the survey form at the display;
generating a second survey storage request at the computer device in response to second survey data input into the second instance of the survey form;
defining, at the computer, a second light sequence presentation comprising a second light sequencing pattern based on the first and second survey data; and
generating the second light sequence presentation to the computer for display.

14. A system for self directed stress assistance comprising:
a processor;
a memory;
a user interface to display at least one light sequence presentation;
a stress assistance application comprising modules executable by the processor to generate the at least one light sequence presentation; the stress assistance application comprising:
an instruction module to transmit a login form and an instruction form for display at the user interface and receive user identification data input into the login form;
a survey module to transmit a survey form for display at the user interface and receive survey data input into the survey form;
a light sequencing module to generate and transmit a first light sequence presentation comprising a first light sequencing pattern for display at the display device; and
a storage module to store identification data and the survey data in the memory.

15. The system of claim 14 further comprising:
an audio module to generate and transmit an audio relaxation presentation.

16. The system of claim 14, wherein the light sequencing pattern is configured in response to an input to the survey form.

17. The system of claim 14, wherein the light sequencing module dynamically generates a second light sequencing pattern for display at the user interface based on at least one of the user identification data and the survey data.

18. The system of claim 14 wherein the first light sequencing pattern is predetermined.

19. The system of claim 14 wherein the first light sequencing pattern is determined based upon the user identification data for the particular user.

20. The system of claim 14 wherein the first light s sequencing pattern is determined based upon the first survey data input.

21. The system of claim 14 wherein the second light sequencing pattern is predetermined.

22. The system of claim 14 wherein the second light sequencing pattern is determined based upon the user identification data for the particular user.

23. The system of claim 14 wherein the second light sequencing pattern is determined based upon the user identification data for the particular user, the first survey data input, and the second survey data input.

24. The system of claim 14 wherein a duration between two or more light patterns of the second light sequencing pattern is increased when the second survey data input equals the first survey data input.

25. The system of claim 14 wherein a duration between two or more light patterns of the second light sequencing pattern is decreased when the second survey data input equals the first survey data input.

26. The system of claim 14 wherein an order of two or more light patterns of the second light sequencing pattern is altered when the second survey data input equals the first survey data input.

27. A system for self directed stress assistance comprising:
a server comprising a first processor, a first memory, and a stress assistance application comprising modules executable by the processor to generate the at least one light sequence presentation, the stress assistance application comprising:
an instruction module to transmit a login form and an instruction form for display at the user interface and receive user data input into the login form;
a survey module to transmit a survey form for display at the user interface and receive survey data input into the survey form;
a light sequencing module to generate and transmit a light sequence presentation comprising a light sequencing pattern for display at the display device; and
a storage module to the store identification data and the survey data in the memory; and
a remote computing device comprising a second processor and a second memory, a user interface to display the light sequence presentation, and an input device to input the user data and the survey data.

28. The system of claim 27, wherein the light sequencing pattern is dynamically configurable in response to the survey data input at the remote computing device.
